(19) United States
(12) Patent Application Publication
(10) Pub. No.: US 2007/0125649 A1
(43) Pub. Date: Jun. 7, 2007

(54) Gas sensor

(75) Inventor: Keiji Kanao, Chita-gun (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/604,234

(22) Filed: Nov. 27, 2006

(30) Foreign Application Priority Data
Dec. 2, 2005 (JP) 2005-349681
Jun. 22, 2006 (JP) 2006-172385

(51) Int. Cl. G01N 27/26

(52) U.S. Cl. 204/424

(57) ABSTRACT

A gas sensor comprises a sensing element for detecting a concentration of a particular gas contained in a measurement gas, a housing holding therein the sensing element, an element cover installed at the top of the housing and a portion for fixing between the base end side of the element cover and the top end side of the housing. The element cover made of an Fe-based alloy containing Al.

### CROSS REFERENCE TO RELATED APPLICATION

This application is based on Japanese Patent Application No. 2005-349681 filed on Dec. 2, 2005, and Japanese Patent Application No. 2006-172385 filed on Jun. 22, 2006 the disclosures of which are incorporated herein by reference.

### FIELD OF THE INVENTION

The present invention relates generally to a gas sensor that may be installed in an exhaust system for measuring a particular gas contained in a measurement gas.

### BACKGROUND OF THE INVENTION

As shown in FIG. 15, Japanese Patent Laid-open Publication No. 2003-185620, describes a gas sensor 9, which is installed in the exhaust system of an internal combustion engine of an automobile and detects a particular gas contained in a measurement gas. The gas sensor 9 comprises a sensing element 910 for detecting the concentration of a particular gas contained in a measurement gas, a housing 911 holding therein the sensing element 910, and an element cover 92 installed at the top end side of the housing 911 and protecting the top end side of the sensing element 910.

The element cover 92 is comprised of a tubular inner cover 921 and a tubular outer cover 922. The base end side of the inner cover 921 is set in the top end side of the housing 911 and the base end side of the outer cover 922 is set in the top end side of the housing 911, outside the inner cover 921.

Recently, the engine is required to have lower fuel consumption and higher output power for an environmental protection. Therefore, temperature of the exhaust gas has increased. As a consequence, since the element cover 92 is subject to heat deterioration, when the element cover 92 receives outside force, such as the exhaust gas pressure or the vibration of the internal combustion engine, there is a concern that the element cover 92 will separate from the housing 911.

### SUMMARY OF THE INVENTION

In view of the above-described problems, it is the object of the present invention to provide an improved gas sensor structure that provides an element cover that has high heat resistance, high oxidation resistance and reliable fixing with a housing.

According to an aspect of the invention, there is a gas sensor that comprises: a sensing element for detecting a concentration of a particular gas contained in a measurement gas; a housing holding therein said sensing element; an element cover installed at the top of said housing; a portion for fixing between the base end side of said element cover and said top end side of said housing; and wherein said element cover made of a Fe-based alloy containing Al.

According to another aspect of the invention, there is a gas sensor that comprises: a sensing element for detecting a concentration of a particular gas contained in a measurement gas; a housing holding therein said sensing element; an element cover installed at the top of said housing; and wherein a coefficient of thermal expansion α of said element cover and a coefficient of thermal expansion β of said housing, which are average coefficients of thermal expansions at a range of 20-850° C., have the relationship of 0<α−β≦2×10⁻⁶/° C.

### BRIEF DESCRIPTION OF THE DRAWINGS

Other objects, features and advantages of the present invention will become more apparent from the following detailed description made with reference to the accompanying drawings, in which:

FIG. 1 is longitudinal section view that shows a gas sensor according to a first embodiment of the present invention;

FIG. 2 is longitudinal section view that shows the top portion of the gas sensor of FIG. 1;

FIG. 3 illustrates an exhaust system of an internal combustion engine according to the first example embodiment of the present invention;

FIG. 4 illustrates a thermal distribution of an element cover according to a comparative example;

FIG. 5 illustrates a thermal distribution of the element cover according to the comparative example;

FIG. 6 is a graph representing a relationship between an amount of aluminium and hardness according to the first example embodiment of the present invention;

FIG. 7 is a graph representing a relationship between an amount of aluminium and the reduction thickness of the element cover according to the first example embodiment of the present invention;

FIG. 8 is a graph representing a relationship between a distance from a fixed portion and a stress ratio according to a second example embodiment of the present invention;

FIG. 9 is longitudinal section view that shows a top portion of a gas sensor according to a third embodiment of the present invention;

FIG. 10 is longitudinal section view that shows a top portion of a gas sensor according to a forth embodiment of the present invention;

FIG. 11 is longitudinal section view that shows a gas sensor according to a fifth embodiment of the present invention;

FIG. 12 is longitudinal section view that shows the top portion of a gas sensor according to a fifth example embodiment of the present invention;

FIG. 13 is another graph representing a relationship between a difference in coefficient of thermal expansion and a stress ratio;

FIG. 14 is a graph representing a relationship between a difference in coefficient of thermal expansion and a stress ratio; and

FIG. 15 is longitudinal section view that shows a gas sensor according to the prior art.

### DETAILED DESCRIPTION OF THE PREFERRED EMBODIMENTS

In this application, an installed side in an exhaust pipe of an internal combustion engine is defined as the top end side, the other side of the top end side is defined as the base end side.

### Example 1

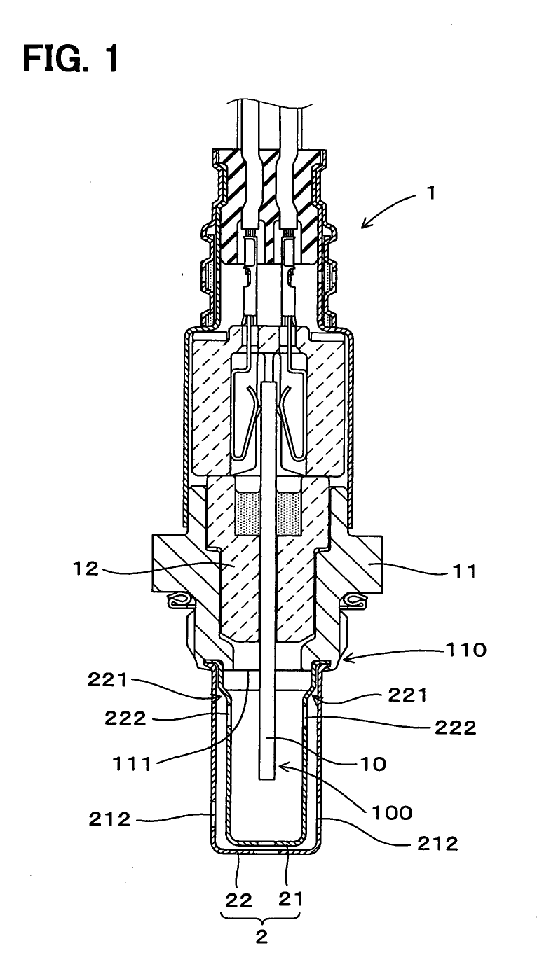

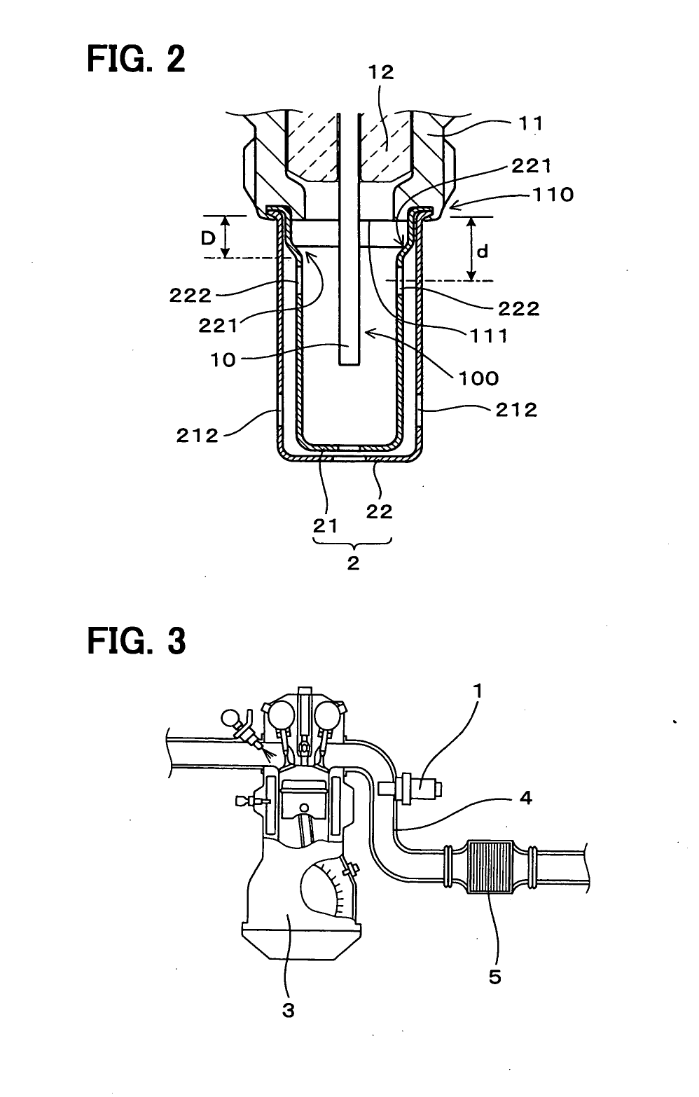

As shown in FIGS. 1-2, a gas sensor 1 comprises, a sensing element 10 for detecting a concentration of the oxygen gas contained in an exhaust gas, a housing 11 holding therein the sensing element 10 via an insulation porcelain 12, and an element cover 2 installed at the top end side of the housing 11.

The top end side 100 of the sensing element 10 protrudes from the top surface 111 of the housing 11.

The element cover 2 is made of a Fe (iron)-based alloy containing Al (aluminium).

The element cover 2 comprises an inner cover 21 formed near the sensing element 10 and an outer cover 22 formed out side of the inner cover 21.

The inner cover 21 and the outer cover 22 are attached to the housing 11 by caulking, welding or a combination of these methods. A portion 110 for fixing between the element cover 21 and the housing 11 is formed at the top end surface 111 of the housing 11.

The sensing element 10 is a plate type element laminating zirconia ceramics and aluminium ceramics. The element cover 2 surrounds the top end side 100 of the sensing element 10 for protecting it from outer pressure, such as exhaust gas, and water.

A first side hole 212 and a second side hole 222 are formed in the sidewall of the inner cover 21 and the outer cover 22. The measurement gas is introduced into the inside of the element cover 2 through the first and second side holes 212, 222 and the concentration of the oxygen gas in the exhaust gas is measured by gas sensor 1.

The first and second side holes 212, 222 does not face each other for efficiently protecting the sensing element 10 from exhaust gas pressure, and water. Adopting the positional relationship of the side holes 212, 222 fully keeps a response property of the gas sensor 1.

As shown in FIG. 3, the gas sensor 1 is installed in an exhaust pipe 4 of an automobile engine 3 and detects the oxygen concentration of the exhaust gas. The gas sensor 1 is installed on an upstream side of a catalyst carrier 5 in the exhaust pipe 4.

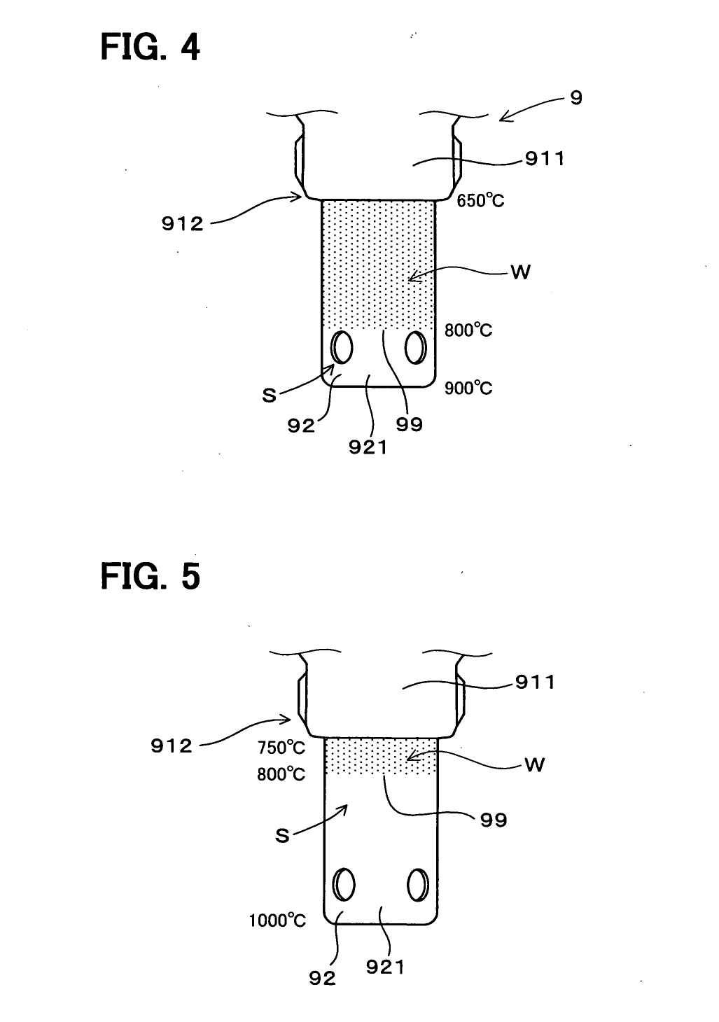

As shown in FIGS. 4-5, the processes of separation of the element cover 92 from the housing 911 were studied.

The element cover 92 of the conventional gas sensor 9 is made of a Ni (nickel)-based alloy containing Al (aluminium). For example, when the element cover 92 is made of Inconel™, which contains 57 atm % Ni, 3 atm % Al and 26 atm % Cr, since the alloy contains Al, an aluminium oxide layer is formed and the heat resistance and the oxidation resistance of the cover may be improved.

However, when the gas sensor 9 is used many times, since the gas sensor 9 is exposed to high temperature gas for a long time, the top end side of the element cover 92 reaches too high a temperature.

In the other hand, Ni reacts with Al to form an intermetallic compound Ni₃Ai and increases a material hardness at 500-800° C. Furthermore, the intermetallic compound Ni₃Ai disintegrates at 800° C. or more.

The temperature of the element cover 92 rises toward top end side, for example 900° C. at the top end side and 650° C. at the base end side is the thermal distribution shown in FIG. 4.

Recently, since the temperature of the exhaust gas is tending upward, the gas sensor 9 is easily exposed to higher temperature exhaust gas. As a consequence, the thermal distribution of the element cover 921 is as illustrated in FIG. 5; 1000° C. at the top end side of the element cover 921 and 750° C. at the base end side thereof. Consequently, a hardness inflection portion 99 that is the border between the area W and the area S is shifted toward the base end side of the element cover 92.

The shifted in hardness inflection portion 99 causes heat deterioration of the element cover 92 and the cover is easily separated from the housing 911.

It is clear that the hardness inflection portion 99 is a cause of separation the element cover 92 from the housing 911.

As mentioned above, in the first example embodiment, the element cover 2 is made of the Fe-based alloy containing Al.

More specifically, in an example embodiment, the Fe—Al alloy is comprised of about 4-8.5 at % Al, about 14-22 at % Cr and, about 50% or more Fe.

In a presently preferred example embodiment, the metallic constitution of the element cover 2 is Fe-based with 6 at % Al and 20 at % Cr.

If the Fe—Al alloy contains Ni (nickel) as an impurity, the amount of Ni is 6 at % or less.

The Al—Fe alloy dose not form an intermetallic compound at any temperature. Therefore, since the element cover 2 is made of a Fe-based alloy containing Al, the intermetallic compound is not formed and the element cover 2 will not tend to separate from the housing 11.

More particularly, even if the element cover 2 receives outside force, such as exhaust gas pressure or vibration from the internal combustion engine, since an intermetallic compound is not formed on the element cover 2, the element cover 2 is prevented from forming a subsidiary fracture by restricting the stress concentration at the base side of the element cover 2. Since the element cover 2 also contains Al, the element cover 2 has superior heat resistance and superior oxidation resistance.

Furthermore, the relationship between the amount of Al in the Fe-based alloy containing Al and the hardness of the element cover 2 were studied.

The condition of the hardness is determined as follows: the element cover 2 is heated by 700° C. and then cooled to room temperature. After that, the hardness of the element cover 2 is measured. The hardness is equal to the Vickers hardness (Hv).

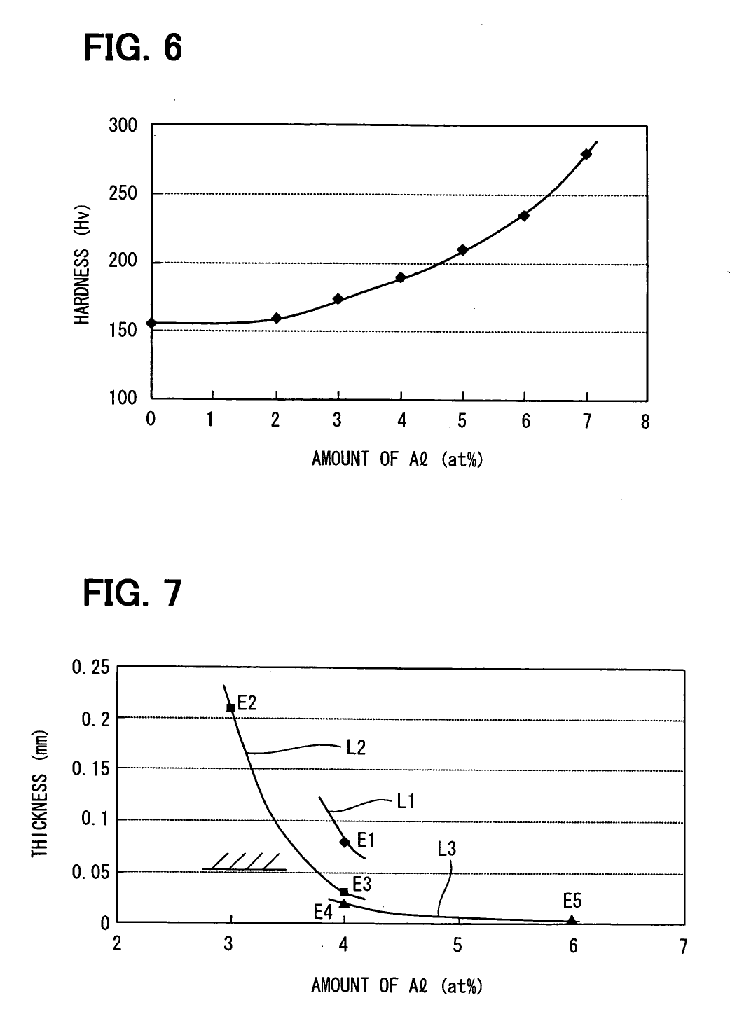

As shown in FIG. 6, when the amount of Al is 2 at % or less, increased hardness of the element cover 2 is fully prevented. The reason for this phenomenon may be that the amount of intermetallic compound Ni₃Al formed is not enough to affect the material hardness.

On the other hand, when the amount of Al is more than 2 at %, the hardness degree is clearly increased. The reason for this phenomenon may be that the amount of intermetallic compound Ni₃Al formed is enough to affect the material hardness.

In addition, the amount of Ni needs be three times of the amount of Al for forming the intermetallic compound Ni₃Al. Therefore, when the element cover 2 is made of a Fe—Al alloy, the element cover 2 is restricted from having an increased hardness by having 6 at % or less Ni when these is 2 at % or less Al.

As mentioned above, the Fe—Al alloy includes no more than 6 at % Ni. Thus, even if the intermetallic compound Ni₃Al is formed, since the amount of the intermetallic compound Ni₃Al is small, the surplus increasing element cover 2 hardness can be prevented. Therefore, the inflection portion of the hardness due to the intermetallic compound Ni₃Al is prevented from forming at the base end side of the element cover 2. As a consequence, a gas sensor 1, which includes an element cover 2 having high heat resistance, high oxidation resistance and reliable fixing with the housing 11, can be provided.

Furthermore, in this example, the Fe—Al alloy is includes Cr. Accordingly, the gas sensor 1, which includes the element cover 2 not only has high heat resistance and high oxidation resistance, but also superior workability.

More specifically, when too much Al is added to the alloy, there is the concern that the workability of the element cover 2 is decreased.

On the other hand, the workability of the element cover 2 can be maintained by adding the Cr to the Fe—Al alloy, the while amount of Al is sufficient to provide an element cover 2 having the high heat resistance and the high oxidation resistance.

As shown in FIG. 7, the element covers 2 made of Fe-based alloys containing the different amounts of Cr and Al are provided. The degree of oxidation resistance of each alloy according to a heat-cold breakdown test was studied.

More specifically, sample E1 is an element cover that is made of 12 atm % Cr and 4 atm % Al, sample E2 is an element cover that is made of 14 atm % Cr and 3 atm % Al, sample E3 is an element cover that is made of 14 atm % Cr and 4 atm % Al, sample E4 is an element cover that is made of 20 atm % Cr and 4 atm % Al, sample E5 an element cover that is made of 20 atm % Cr and 6 atm % Al.

The conditions of the heat-cold breakdown test are as follows: the element cover is heated for 6 minutes so that the maximum temperature thereof is 1000° C. and then the element cover is cooled for 4 minutes so that the minimum temperature thereof is 150° C. This process from heating to cooling is regarded as 1 cycle. The cycle is carried out 1000 times.

In the example, the degree of the influential oxidation resistance is regarded as the decreased thickness of the element cover by oxidizing.

The test results are indicated the plot of FIG. 7.

Connecting the data for 12 at %, 14 at % and 20 at % Cr makes curved lines L1-L3.

Even when element cover is exposed to the severe environment, the oxidation resistance of the element cover, whose composition is 4 at % or more Al and 14 at % or more Cr, is ensured.

The Fe—Al alloy is made of about 14-22 at % Cr and about 4-8 at % Al. Therefore, the element cover can have high heat resistance, high oxidation resistance and high workability.

On the other hand, when the amount of Cr is less than 12 at %, there is the concern that an element cover having high heat resistance and high oxidation resistance cannot be provided.

When the amount of Cr is more than 22 at %, there is a concern that an element cover having high workability cannot be provided.

Furthermore, when the amount of Al is less than 4 atm %, there is the concern that the element covers having high heat resistance and high oxidation resistance cannot be provided.

When the amount of Al is more than 8.5 atm %, there is a concern that an element cover having high workability cannot be provided.

### Example 2

Furthermore, the relationships between the distance from the fixed portion to the heat stress were studied.

The measuring method of the stress is that, when the top end side of the element cover is given a shock of 1000 G in a direction the perpendicular to the axial direction thereof, each the stress existing at each point on the element cover is measured by FEM analysis. The stress ratio indicates the test result.

The stress ratio indicates in the ratio of the stress at each portion to the stress at a position 4 mm from the fixed portion.

The tested element covers had the same thickness, the same diameter and did not have side holes.

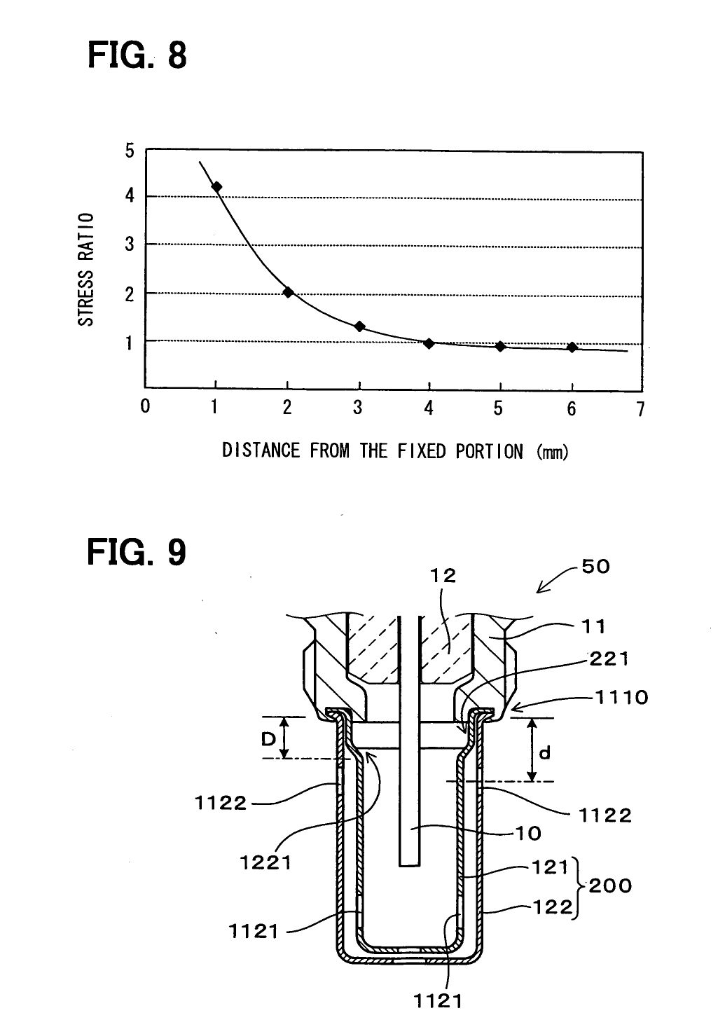

As shown in FIG. 8, the stress ratio at portions of the over 4 mm from the fixed portion is almost same as the stress ratio at the portion that is 4 mm from the fixed portion.

On the other hand, the stress ratio increases at the portion 4 mm or less from the fixed portion.

Especially, the stress ratio at the portion 2 mm or less from the fixed portion is remarkably increased and is double the stress ratio at the portion 4 mm from the fixed portion.

As mentioned above, conducting this test clearly demonstrates that stress is strongly produced at the position 4 mm or less, especially 2 mm or less, from the fixed portion. As a consequence, when the structure or the shape which are the function of the stress concentration or the strength reduction, such as the changing diameter position or the side hole, are formed a position that is 4 mm or less from the fixed portion, the element cover is subject to having a subsidiary fracture.

Therefore, in the first example embodiment of the invention, though the changing diameter or the side hole is at the position that is 4 mm or less, especially 2 mm or less, from the fixed portion are formed in the element cover, since the element cover is made of a Fe—Al alloy, the element cover can be efficiently prevented from having the subsidiary fracture.

More specifically, as shown in FIGS. 1-2, the changing diameter position 221 and the first side hole 221 in the inner cover 22 is formed at a position 4 mm or less from the fixed portion 110 (shown as D and d). On the other hand, the element cover 2 is made of a Fe—Al alloy. Therefore, as mentioned above, even though the changing diameter and the center of the first side hole 221 are formed at a position that is 4 mm or less from the fixed portion 110, the element cover 2 can be efficiently prevented having a subsidiary fracture.

### Example 3

As shown in FIG. 9, the gas sensor 50 comprises a changing diameter portion 1221 in an inner cover 121 and a second side hole 1122 in an outer cover 122. The changing diameter portion 1221 and the central second side hole 212 are formed at a position that is 4 mm or less from the fixed potion 1110.

The inner cover 121 and the outer cover 122 are made of the Fe—Al alloy.

In this example embodiment, the mentioned above, the changing diameter portion 1221 and the second side hole 1122 are formed at an area of easy subsidiary fracture. However, since the inner cover 121 and the outer cover 122 are made of a Fe—Al alloy, the element cover 200 is efficiently prevented from having a subsidiary fracture without influence of the location of the changing diameter portion 1221 and the second side hole 1122.

The element cover 200 can be efficiently prevented from having a subsidiary fracture by adopting this example.

Otherwise the aspects of this example embodiment are the same as Example 1.

### Example 4

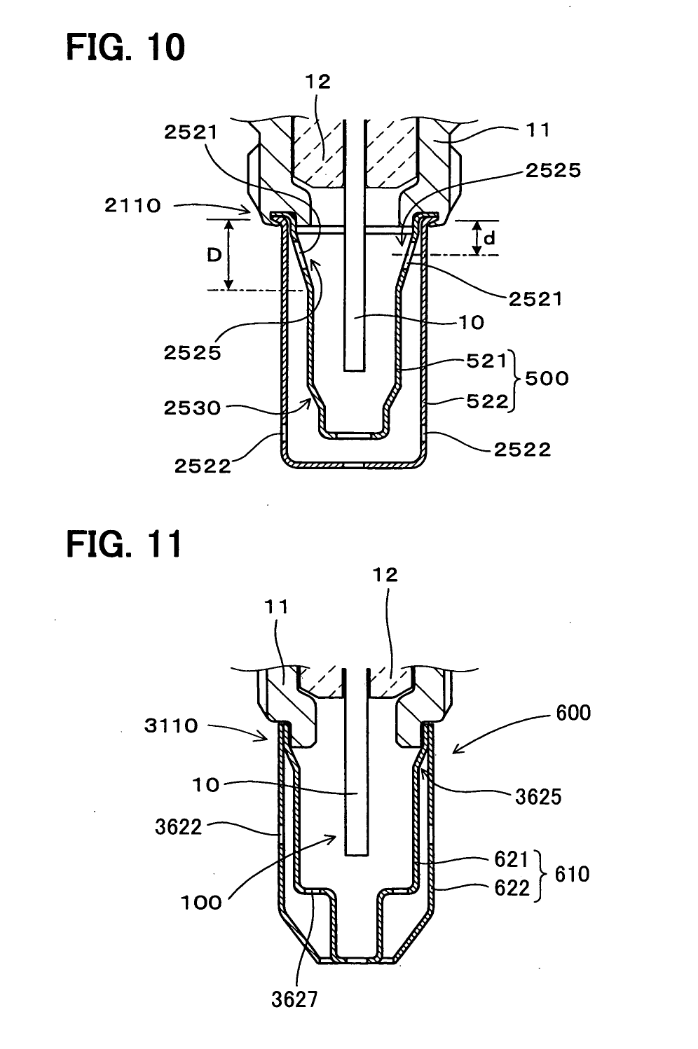

As shown in FIG. 10, an element cover comprises an inner cover 521 and an outer cover 522. A first side hole 2521 and a first changing diameter portion 2525 in the inner cover 521 are formed at positions that are 4 mm or less from a fixed portion 2110. Furthermore, the first side hole 2521 is formed at the changing diameter portion 2525.

A second changing diameter portion 2530 is also formed at the top end side of the inner cover 521. The changing diameter portion 2530 is formed at the position that is more than 4 mm from the fixed portion 2110. On the other hand, there is no changing diameter portion in the outer cover 522 and a second side hole 2522 is also formed near the top end side of the outer cover 522.

The inner cover 521 is made of a Fe—Al alloy. Preferably the outer cover 522 is made of a Fe—Al alloy, but the outer cover 522 can be made of some other kind of alloy.

The element cover 500 can also be efficiently prevented from having a subsidiary fracture by adopting this example.

Otherwise the aspects of this example embodiment are the same as Example 1.

### Example 5

As shown in FIG. 11, a gas sensor 600 is installed an element cover 610 and a housing 11 fixed with the base end side thereof by laser welding. The element cover 610 is comprised an inner cover 621 and an outer cover 622. A first changing diameter portion 3625 in the inner cover 621 is formed at a position that is 4 mm or less from the fixed portion 3110. A second changing diameter 3527 and a first side hole 3627 in the inner cover 621 and a second side hole 3622 in the outer cover 622 are formed at positions that are more than 4 mm from the fixed portion 3110. Furthermore, the first side hole 3627 is formed in the second changing diameter portion 3625.

The inner cover 621 is made of a Fe—Al alloy. Preferably the outer cover 622 is made of a Fe—Al alloy, but the outer cover 622 can be made of another kind of alloy.

The element cover 610 can also be restricted from separating from the housing 11.

Otherwise the function and result of this example embodiment is the same as Example 1.

### Example 6

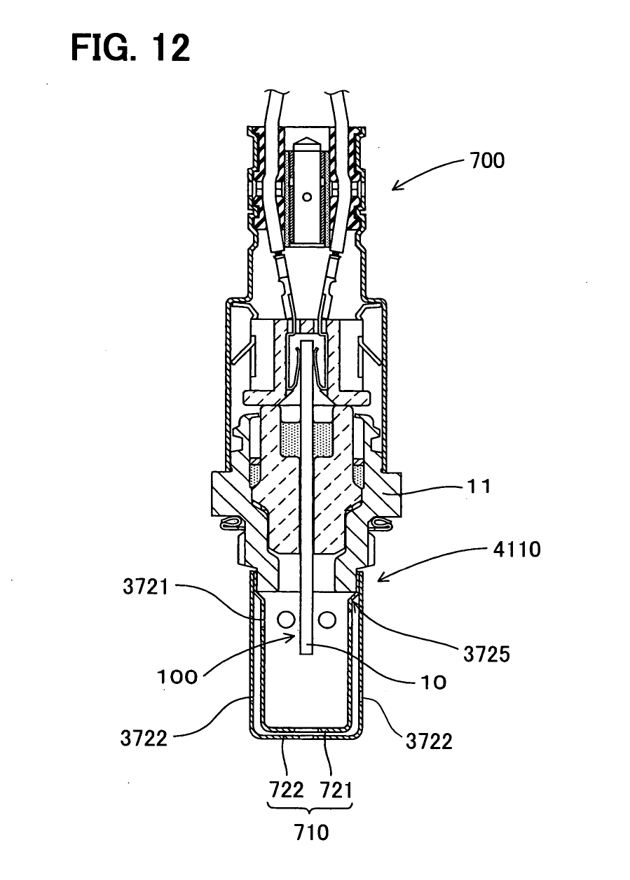

As shown in FIG. 12, a fixed portion 4110 of a gas sensor 700 as test samples is different from the fixed portion 110 of the gas sensor 1. Namely, the fixed portion 4110 at a base end side of an element cover 710 is fixed to the outer circumference of the housing 11 by laser welding. A first side hole 3721 and a changing diameter 3725 in an inner cover 721 are formed at a position that is 4 mm or less from the fixed portion 4110. A second side hole 3722 in an outer cover 722 is formed at a position that is more than 4 mm from the fixed portion 4110.

The housing 11 is made of a stainless including ferrite.

The element cover 710 is made of a Fe-based alloy containing 4-8.8 at % Al, 14-22 at % Cr and 6 at % or less Ni.

Since the element cover 710 and the housing 11 are made of a Fe-based alloy, the difference in the coefficient of thermal expansion between that (α) of the element cover 710 and that (β) of the housing 11 complies with the relationship 0<α−β≦2×10⁻⁶.

The difference in the coefficient of thermal expansion is that difference between the average coefficient of thermal expansion of the element cover 710 and that of the housing 11 in the range of 20° C.-850° C.

The relationship between the difference in the coefficient of thermal expansion between the element cover 710 and the housing 11 and the heat stress at the fixed portion 4110 were studied.

The gas sensor structures used as samples were the same as FIG. 11.

The gas sensors having each various differences in coefficient of thermal expansion in the range of 1.0×10⁻⁶−4.3×10⁻⁶/° C. were provided for analyzing the coefficient of thermal expansion.

The heat stresses produced at the fixed portion 3110 were measured at 850° C. When the difference in the coefficient of thermal expansion was 1.0×10⁻⁶/° C., the heat stress at the fixed portion 4110 was regarded as “1” and the heat stress ratio of the heat stress at each coefficient of thermal expansion to the heat stress at 1.0×10⁻⁶/° C. were calculated.

850° C. is regarded as the closely resembling the temperature at when the gas sensor is exposed to the exhaust gas on the assumption that the gas sensor is used under normal condition.

FIG. 12 depicts the relationship between the difference in the coefficient of thermal expansion and the stress ratio. When the difference in the coefficient of thermal expansion is 2.0×10⁻⁶/° C. or less, since the stress ratio is less than 1.1, the heat stress can be fully decreased. On the other hand, when the difference in the coefficient of thermal expansion is 3.0×10⁻⁶/° C. or more, since the stress ratio is over 1.2, the heat stress produced at the fixed portion 4110 is increased.

Furthermore, heat-cold bench tests were conducted for confirming the above result. Two types of gas sensors having the each element cover made of NCF601 alloy (Inconel 601) and FCH2 alloy (Fe-18Cr-3Al, wt %) are provided as samples.

Otherwise the sample structures were the same as FIG. 11.

Five samples of each sample type were provided.

The conditions of the heat-cold bench test were as follows: the gas sensor is heated for 6 minutes so that the maximum temperature thereof is 850° C. and the gas sensor is cooled for 6 minutes so that the minimum temperature thereof is 600° C. This process from heating to cooling is regarding as 1 cycle. The cycle is carried out 1000 times. After that, the cross-sectional fixed portion between the element cover and the housing of the samples were examined for the generation status of a crack.

The difference in the coefficient of thermal expansion between the NCF 601 alloy and the housing 11 is 4.3 10⁻⁶/° C. and the difference of the coefficient of thermal expansion between the FCH 2 alloy and the housing 11 is 4.3 10⁻⁶/° C.

The results of the heat-cold bench tests are descried. None of the element cover samples made of the FCH 2 alloy had a crack at the fixed portion. On the other hand, all five element cover samples made of the NCF 601 alloy had a crack at the fixed portion.

As a consequence, when the difference in the coefficient of thermal expansion between the element cover and the housing is 2.0×10⁻⁶/° C. or less, the stress at the fixed portion due to the rising temperature can be sufficiently restricted.

As mentioned above, when the difference in the coefficient of thermal expansion is 2.0×10⁻⁶/° C. or less, the heat stress can be fully decreased.

Next, the lowest limit of the difference in the coefficient of thermal expansion was studied.

The some samples having the differences in the coefficient of thermal expansion in the range from −2.0×10⁻⁶/° C.˜2.0×10⁻⁶/° C. were provided.

The conditions of the heat stress analysis on the assumption that the gas sensor is regarded as carrying out the fuel-cut control are as follows: when the temperature of the inner surface of the housing 11 is 850° C. and the temperature of the outer surface of the element cover is 250° C., the heat stresses produced at the fixed portion were measured. After that, when the difference in the coefficient of thermal expansion was 0, the heat stress at the fixed portion was regarded as 1. The heat stress ratios of the heat stress of each sample of the heat stress regarding as 1 were calculated.

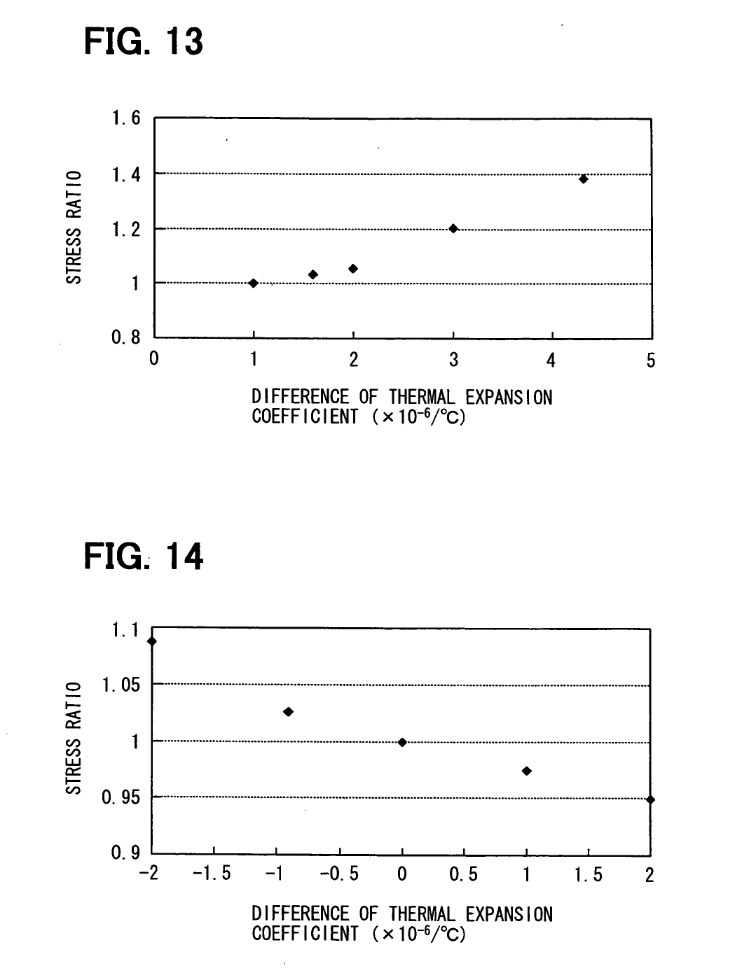

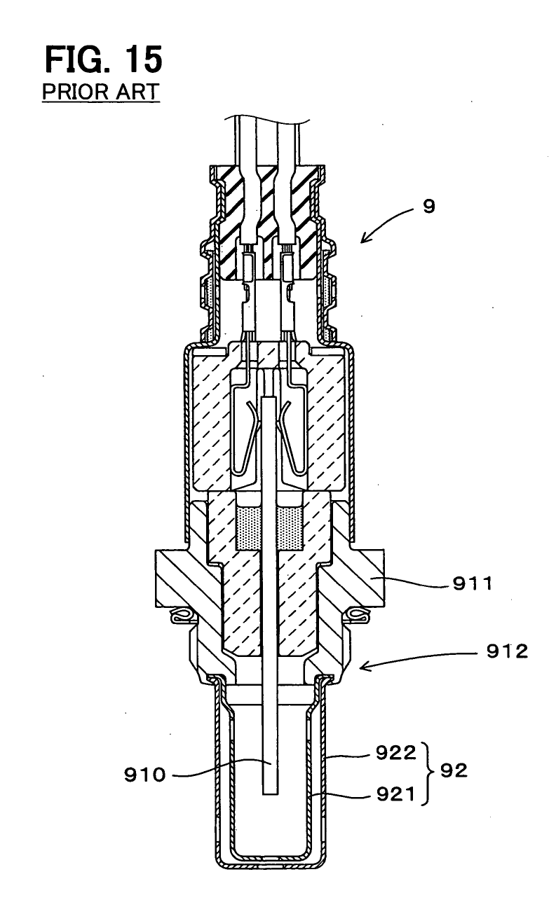

FIG. 13 depicts the results of the heat stress analysis of these samples.

When the difference in the coefficient of thermal expansion is more than 0, namely, when the coefficient of thermal expansion of the element cover is larger than that of housing, the heat stress ratio is less than 1. Therefore, the heat stress produced at the fixed portion can be decreased. On the other hand, when the difference in the coefficient of thermal expansion is less than 0, the heat stress ratio is more than 1.

As a consequence, even in a special situation, such as conducting fuel cut control, when the coefficient of thermal expansion of the element cover is larger than that of housing, the heat stress produced at the fixed portion can be fully decreased.

Next, the function and result will be described on the based on the result of the above tests.

The reference numbers used are those in FIG. 11. When the coefficients of thermal expansion α and β have the relationship 0<α−β≦2×10⁻⁶, the element cover 710 is sufficiently restricted to separate from the gas sensor 700.

More specifically, when the fuel cut control is carried out, the gas sensor 700 at high temperature is immediately exposed to low temperature air. Since the element cover 710 is easily exposed to low temperature air and has the comparatively small heat volume, the element cover 710 is suddenly cooled. On the other hand, since the housing 11 is difficult to expose to low temperature air and has comparatively large heat volume, the housing 11 is easily kept at a high temperature. As a consequence, the element cover 710 suddenly shrinks and the housing 11 only shrinks a little.

In this example, since the coefficient of thermal expansion α of the element cover 710 is larger than the coefficient of thermal expansion β of the housing 11 (same as 0<α−β), the element cover 710 is expands more than the housing 11 at high temperature. Thus, since the element cover 710 starts shrinking from the expanded situation, the amount of the slipping between the element cover 710 and housing 11 can keep a small and the fixed portion 4110 is restricted from producing the thermal stress.

Furthermore, since the coefficients of thermal expansion α and β comply with the relationship α−β≦2×10⁻⁶/° C., the element cover 710 is restricted from expanding beyond the housing 11 when temperature rises. Thus, the fixed portion 4110 can avoid receiving the too much heat stress.

As a consequence, the fixed portion 4110 can avoid cracking and the element cover 710 is prevented from having a subsidiary fracture. Furthermore, the fixed portion 4110 can prevent the element cover 710 from separating from the housing 11.

Since the element cover 610 and the housing 11 are fixed by laser welding at the entire circumference thereof, the fixed strength between the element cover 710 and housing 11 at the fixed portion can be ensured. Thus, the element cover 710 can be restricted from separating from the housing 11.

Otherwise the function and result of this example embodiment are the same as Example 1.

Although the present invention has been fully described in connection with the preferred embodiments thereof with reference to the accompanying drawings, it is to be noted that various changes and modifications will become apparent to those skilled in the art.

For example, the gas sensor may be on NOₓ sensor, oxygen sensor, air-fuel sensor and so on.

The gas sensor is installed on the upstream side of the exhaust purify catalyst of the internal combustion engine.

Thus, since the temperature on the upstream side is higher than the temperature on the downstream side in the exhaust pipe, the element cover of the gas sensor is subject to subsidiary fracture and separation from the housing. When the gas sensor is installed on the upstream side of the exhaust purifying catalyst, the function and result of the invention are more efficiently provided.

Such changes and modifications are to be understood as being within the scope of the present invention as defined by the appended claims.

What is claimed is:

1. A gas sensor comprising:
a sensing element for detecting a concentration of a particular gas contained in a measurement gas;
a housing holding therein said sensing element;
an element cover installed at the top end side of said housing;
a portion for fixing the base end side of said element cover and the top end side of said housing; and wherein
said element cover made of a Fe-based alloy containing Al.

2. A gas sensor according to in claim 1 wherein said Fe-based alloy contains about 4-8.5 at % Al.

3. A gas sensor according to claim 1 wherein said Fe-based alloy contains about 50 at % or more Fe.

4. A gas sensor according to claim 1 wherein said Fe-based alloy contains about 6 at % or less Ni.

5. A gas sensor according to claim 1 wherein said Fe-based alloy further contains Cr.

6. A gas sensor according to claim 5 wherein said Fe-based alloy contains about 14-22 at % Cr.

7. A gas sensor according to claim 6 wherein said Fe-based alloy contains about 4-8.5 at % Al.

8. A gas sensor according to claim 1 wherein said element cover has a changing diameter portion where the diameter decreases from a base end side to a top end side thereof.

9. A gas sensor according to claim 8 wherein said changing diameter is formed at a portion that is 4 mm or less from said fixed portion.

10. A gas sensor according to claim 9 wherein said changing diameter is formed at a portion that is 2 mm or less from said fixed portion.

11. A gas sensor according to claim 1 wherein said element cover is comprised of an inner cover formed near said sensing element and an outer cover formed outside of said inner cover and side holes are formed in said inner cover and said outer cover.

12. A gas sensor according to claim 11 wherein at least said cover having a side hole nearer said housing is made of said Fe-based alloy containing Al.

13. A gas sensor according to claim 12 wherein the center of said side hole nearer said housing is formed at a position that is 4 mm or less from said housing.

14. A gas sensor according to claim 13 wherein the center of said side hole nearer said housing is formed at a position that is 2 mm or less from said housing.

15. A gas sensor according to claim 1 wherein said gas sensor is installed on an upstream side of a catalyst carrier in the exhaust pipe.

16. A gas sensor according to claim 1 wherein said element cover and said housing are fixed by laser welding, resistant welding or a combination of these methods.

17. A gas sensor according to claim 16 wherein said element cover and said housing are fixed by welding at the entire circumference thereof.

18. A gas sensor comprising:
a sensing element for detecting a concentration of a particular gas contained in a measurement gas;
a housing holding therein said sensing element;
an element cover installed at the top of said housing; and wherein
a coefficient of thermal expansion α of said element cover and a coefficient of thermal expansion β of said housing, which are average coefficients of thermal expansions at a range of 20-850° C., have the relationship 0<α−β≦2×10−6/° C.

19. A gas sensor according to claim 18 wherein said housing is made of a stainless steel including ferrite and said element cover is made of a Fe-based alloy containing Al.

20. A gas sensor according to claim 18 wherein said Fe-based alloy contains about 50 at % or more Fe.

21. A gas sensor according to claim 18 wherein said Fe-based alloy contains about 4-8.5 at % Al.
